(19) United States
(12) Patent Application Publication
(10) Pub. No.: US 2024/0355175 A1
(43) Pub. Date: Oct. 24, 2024

(54) PURCHASE OFFERS AT A GAMING DEVICE IN A CASINO ENVIRONMENT BASED ON PLAYER STATUS

(71) Applicant: IGT, Las Vegas, NV (US)

(72) Inventors: Michael RUSS, Graz (AT); David FROY, Lakeville-Westmorland (CA); Stefan KEILWERT, St. Josef (AT); Soheil LATIFI, Brampton (CA)

(73) Assignee: IGT, Las Vegas, NV (US)

(21) Appl. No.: 18/136,525

(22) Filed: Apr. 19, 2023

(51) Int. Cl. G07F 17/32

(52) U.S. Cl. CPC G07F 17/3244; G07F 17/3223

(57) ABSTRACT

A processor circuit generates a first game result for a wagering game, including a bonus game trigger event. Based on the bonus game trigger event, a bonus game, and a user selection of a subset of bonus game features from a plurality of available bonus game features is received. Based on the selection of the subset of bonus game features, the subset of bonus game feature is applied to the bonus game and a bonus game result for the bonus game is generated.

### BACKGROUND

Embodiments described herein relate to purchase offers at a gaming device, and in particular to purchase offers at a gaming device in a casino environment based on player status. Casinos may offer purchases of goods and services, and may provide promotional give aways using player points. Many of these offers may relate to general merchandise and unrelated to specific games being played in the casino. Additional purchase options for players of wagering games in a casino environment may increase player enjoyment and engagement.

### BRIEF SUMMARY

According to some embodiments, a system includes a processor circuit and a memory including machine-readable instructions. When executed by the processor circuit, the instructions cause the processor circuit to determine a player status of a player in a wagering game play session at a gaming device in a casino. The instructions further cause the processor to, based on the player status of the player, cause a display device of the gaming device to display an offer to the player to purchase a physical item. The instructions further cause the processor to, in response to acceptance of the offer by the player, transmit an instruction to prepare the physical item for delivery to the player. The instructions further cause the processor to, after completion of the wagering game play session, the physical item to be delivered to the player.

According to some embodiments, a gaming device includes a display device, an input device, a processor circuit, and a memory including machine-readable instructions. When executed by the processor circuit, the instructions cause the processor circuit to determine a player status of a player in a wagering game play session at a gaming device in a casino. The instructions further cause the processor to, based on the player status of the player being a first status, cause a display device of the gaming device to display a first plurality of purchase offers to the player. The instructions further cause the processor to, based on the player status of the player being a second status, cause a display device of the gaming device to display a second plurality of purchase offers to the player, wherein a subset of the second plurality of purchase offers is not included in the first plurality of purchase offers.

According to some embodiments a method includes determining, by a processor circuit, a player status of a player in a wagering game play session at a gaming device in a casino. The method further includes, based on the player status of the player, displaying, at a display device of the gaming device, an offer to the player to purchase a physical item. The method further includes, in response to acceptance of the offer by the player, transmitting an instruction to prepare the physical item for delivery to the player. The method further includes, after completion of the wagering game play session, delivering the physical item to the player.

### BRIEF DESCRIPTION OF SEVERAL VIEWS OF THE DRAWINGS

FIG. 1 is a schematic block diagram illustrating a network configuration for a plurality of gaming devices according to some embodiments.

FIG. 2A is a perspective view of a gaming device that can be configured according to some embodiments.

FIG. 2B is a schematic block diagram illustrating an electronic configuration for a gaming device according to some embodiments.

FIG. 2C is a schematic block diagram that illustrates various functional modules of a gaming device according to some embodiments.

FIG. 2D is perspective view of a gaming device that can be configured according to some embodiments.

FIG. 2E is a perspective view of a gaming device according to further embodiments.

FIGS. 3A and 3B are diagrams of a GUI for an EGM in a casino environment illustrating a purchase offer based on a player status of a player, according to some embodiments.

FIGS. 4A and 4B illustrate delivery of the physical item to a player at the EGM, according to some embodiments.

FIGS. 5A-5C illustrate the player taking delivery of the physical item at a customer service area elsewhere in the casino and/or at another location, according to some embodiments.

FIGS. 6A-6C illustrate the player taking delivery of the physical item at a from a vending kiosk elsewhere in the casino and/or at another location, according to some embodiments.

FIG. 7 illustrates initiating shipping of the purchased physical item to a selected address of player at the EGM, according to some embodiments.

FIGS. 8A and 8B illustrate offering different purchase offers in response to different player statuses, according to some embodiments.

FIG. 9 is a flowchart illustrating operations for providing purchase offers to a player of a wagering game at a gaming device in a casino environment, according to some embodiments.

### DETAILED DESCRIPTION

Embodiments described herein relate to purchase offers at a gaming device, and in particular to purchase offers at a gaming device in a casino environment based on player status.

According to some embodiments, a system includes a processor circuit and a memory including machine-readable instructions. When executed by the processor circuit, the instructions cause the processor circuit to determine a player status of a player in a wagering game play session at a gaming device in a casino. Based on the player status of the player, a display device of the gaming device to displays an offer to the player to purchase a physical item. In response to acceptance of the offer by the player, an instruction is transmitted to prepare the physical item for delivery to the player. After completion of the wagering game play session, the physical item is delivered to the player.

In some embodiment, items shown in slot games in the casino may be shoppable directly from the gaming device. This this may include purchase of items shown on an EGM screen, and may also include game-related mechanisms that may make the player eligible to purchase different items and assets under different conditions, such eligibility to purchase an item at a given price and/or at a discount, up to and including eligibility to purchase the item at all.

Items and other assets that may be made available for purchase may include physical products and digital content, which may be purchased using player tracking cards, credit cards and/or mobile devices for authentication and/or payment. As discussed above, casinos may offer purchases of goods and services, and may provide promotional give aways using player points and relating to general and/or casino-themed merchandise. To increase player enjoyment and engagement, embodiments disclosed herein may provide purchase opportunities relating to specific game titles and/or themes. For example, a player may accumulate, e.g. purchase, collect, etc., discount points directly from within a game and/or by making progress in the game, thereby increasing engagement for players with achievement-focused playstyles, and who might continue playing a game to collect additional assets related to a particular game, game series, game theme, etc.

Purchasing of assets may occur at different devices, such as EGMs or vending kiosks, and my use casino loyalty card transactions (which may allow a player to purchase loyalty points), credit or bank card transactions, mobile payment (e.g., via an NFC connection, QR code scanning, etc.), instant payment providers, and/or a player's credit balance at an EGM, etc. In some examples, the EGM, kiosk, or other device may be in communication with a purchase server system configured to process real-time transactions.

Delivery of digital assets may include transmission of the digital assets wirelessly to a mobile device, generating and/or displaying a download link or QR code, transmitting link or content via email, SMS, instant messenger, etc., saving the assets to a player's loyalty account, and/or storing the assets within a dedicated application, with the assets being accessible, viewable, and/or downloadable from within the app.

Delivery of physical items may include delivering the physical item to an EGM or other location, and/or sending purchase information to a customer service area, e.g., a casino's asset shop, service desk, etc., where the physical item is prepared for pickup by the player. Items may be purchased directly at a customer service area, such as by presenting a loyalty card containing relevant information, such as game progress made, purchase eligibility status, etc., using currency, loyalty points, etc. The EGM may print an item receipt using the EGM's ticket printer, which may be redeemed at the customer service area. In some examples, the item may be shipped directly to the player's home address or another address.

In this manner, game-related assets may be sold directly from within a wagering game, which may enhance enjoyment of the game by the player, and which may draw the player's attention towards trying new games, e.g., promoting the game itself as well as the purchasable assets associated with the game.

In some examples, higher discount rewards and/or more advanced assets may be provided a game, the more they play the game, to encourage an increased rate of play. In some examples, different shoppable assets may be displayed on the EGM screen, such as in-game characters of the slot game wearing clothes, accessories, etc., which can directly be shopped from the EGM. For example, beginning with a standard slot game with standard interchangeable game elements, characters in the game may be modified to display clothing from a clothing brand's collection in-game, as an advertisement for the brand, and as a way of enabling direct purchase of the brand's merchandise from within the game. The player may select the desired piece of clothes, view prices, and purchase the clothes directly from the game, to be prepared and delivered and/or picked up from the casino at a later time. In some examples, if the player purchases a certain amount of merchandise and/or spends a certain amount of money, time, etc., playing that game, they may become eligible for a discount on the clothes purchase and/or subsequent clothes purchases. In some examples, certain items or assets may have different rarities, with rarer items being available for different eligibility levels. In some examples, players may unlock items that are available to purchase for the characters in game. In some examples, certain game play achievements may unlock items to be purchased, and/or may earn free bonus items.

A player might decide to purchase an asset shown within a game in the casino. By having a tracking card inserted into the machine, the casino would know who ordered the asset and can prepare it directly within the casino, ready to pick off after the game session, at casino check out, etc. This preparation may occur in response to a player selection and/or may occur automatically in the background, e.g., based on player and/or operator preferences. Identifying information associated with a player tracking account, such as clothes size, may be accessed automatically, to streamline the asset selection and purchase process.

In some examples, a player may only be eligible to purchase certain items related to a game after actually playing that particular game, after making a sufficient number of wagers, after achieving a particular status or game progression. In some examples, the items may be available for purchase by the general public, with play of the game unlocking discounts and other benefits associated with the purchase. In some examples, the asset may only be available and/or unlockable for a limited time, and/or may only be purchasable if other related items have previously been purchased and/or are purchased at the same time, e.g., as a collection.

In some embodiments, specific items and/or assets may be purchased from different casino locations, each with location-specific items available for purchase exclusively at that location. Purchasing multiple items from multiple locations may unlock eligibility to purchase additional items, e.g., new digital content, real life rewards, more favorable in-game rules (e.g., betting/denomination options, new game rules, etc.), and other benefits. Other benefits may include casino specific credits, benefits at another EGM and/or game at the same property and/or another property, faster rate of accumulation of player points, access to different secondary games such as legacy secondary games that may no longer be available to the general public.

In some examples, certain bonus games may be enabled by a player purchasing or owning a particular item or asset, and/or playing a specific game feature and/or bonus game to unlock the ability to purchase an item or asset. In some example, a subscription service may periodically unlock new and different items or assets for purchase, and/or may unlock different game features and/or bonus or secondary games. In some examples, a base subscription may include one tier of items and/or assets, with the option to purchase higher-tier items and/or assets, e.g., with an upgraded subscription. In some examples, purchasing an item without the subscription may not include any additional benefit, but purchasing the item with a subscription may include additional items, in-game benefits, etc.

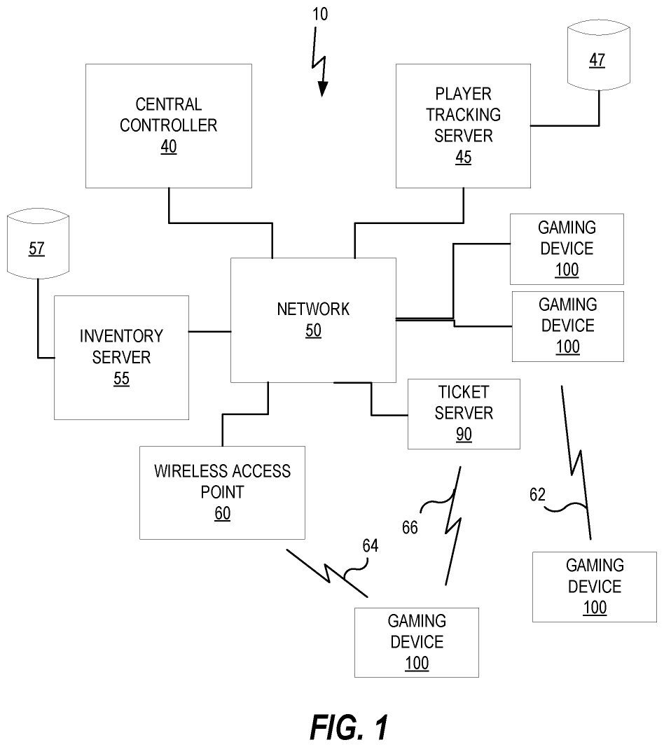

Before describing these and other features in greater detail, reference is now made to FIG. 1, which illustrates a gaming system 10 including a plurality of gaming devices 100. The gaming devices 100 may be one type of a variety of different types of gaming devices, such as electronic gaming machines (EGMs), mobile gaming devices, or other devices, for example.

The gaming system 10 may be located, for example, on the premises of a gaming establishment, such as a casino. The gaming devices 100, which are typically situated on a casino floor, may be in communication with each other and/or at least one central controller 40 through a data communication network 50 that may include a remote communication link. The data communication network 50 may be a private data communication network that is operated, for example, by the gaming facility that operates the gaming devices 100. Communications over the data communication network 50 may be encrypted for security. The central controller 40 may be any suitable server or computing device which includes at least one processing circuit and at least one memory or storage device. Each gaming device 100 may include a processing circuit that transmits and receives events, messages, commands or any other suitable data or signal between the gaming device 100 and the central controller 40. The gaming device processing circuit is operable to execute such communicated events, messages or commands in conjunction with the operation of the gaming device 100. Moreover, the processing circuit of the central controller 40 is configured to transmit and receive events, messages, commands or any other suitable data or signal between the central controller 40 and each of the individual gaming devices 100. In some embodiments, one or more of the functions of the central controller 40 may be performed by one or more gaming device processing circuits. Moreover, in some embodiments, one or more of the functions of one or more gaming device processing circuits as disclosed herein may be performed by the central controller 40.

A wireless access point 60 provides wireless access to the data communication network 50. The wireless access point 60 may be connected to the data communication network 50 as illustrated in FIG. 1, and/or may be connected directly to the central controller 40 or another server connected to the data communication network 50.

A player tracking server 45 may also be connected through the data communication network 50. The player tracking server 45 may manage a player tracking account that tracks the player's gameplay and spending and/or other player preferences and customizations, manages loyalty awards for the player, manages funds deposited or advanced on behalf of the player, and other functions. Player information managed by the player tracking server 45 may be stored in a player information database 47.

An inventory server 55 may also be connected through the data communication network 50. The inventory server 55 may manage inventory of goods, services, prizes, and other items, and may manage transfer and/or delivery of items to and from the casino or other organization, e.g., to players and other individuals as awards and purchased items. Inventory information managed by the inventory server 55 may be stored in an inventory information database 57.

As further illustrated in FIG. 1, the gaming system 10 may include a ticket server 90 that is configured to print and/or dispense wagering tickets. The ticket server 90 may be in communication with the central controller 40 through the data communication network 50. Each ticket server 90 may include a processing circuit that transmits and receives events, messages, commands or any other suitable data or signal between the ticket server 90 and the central controller 40. The ticket server 90 processing circuit may be operable to execute such communicated events, messages or commands in conjunction with the operation of the ticket server 90. Moreover, in some embodiments, one or more of the functions of one or more ticket server 90 processing circuits as disclosed herein may be performed by the central controller 40.

The gaming devices 100 communicate with one or more elements of the gaming system 10 to coordinate providing wagering games and other functionality. For example, in some embodiments, the gaming device 100 may communicate directly with the ticket server 90 over a wireless interface 62, which may be a WiFi link, a Bluetooth link, a near field communications (NFC) link, etc. In other embodiments, the gaming device 100 may communicate with the data communication network 50 (and devices connected thereto, including other gaming devices 100) over a wireless interface 64 with the wireless access point 60. The wireless interface 64 may include a WiFi link, a Bluetooth link, an NFC link, etc. In still further embodiments, the gaming devices 100 may communicate simultaneously with both the ticket server 90 over the wireless interface 66 and the wireless access point 60 over the wireless interface 64. Some embodiments provide that gaming devices 100 may communicate with other gaming devices over a wireless interface 64. In these embodiments, wireless interface 62, wireless interface 64 and wireless interface 66 may use different communication protocols and/or different communication resources, such as different frequencies, time slots, spreading codes, etc.

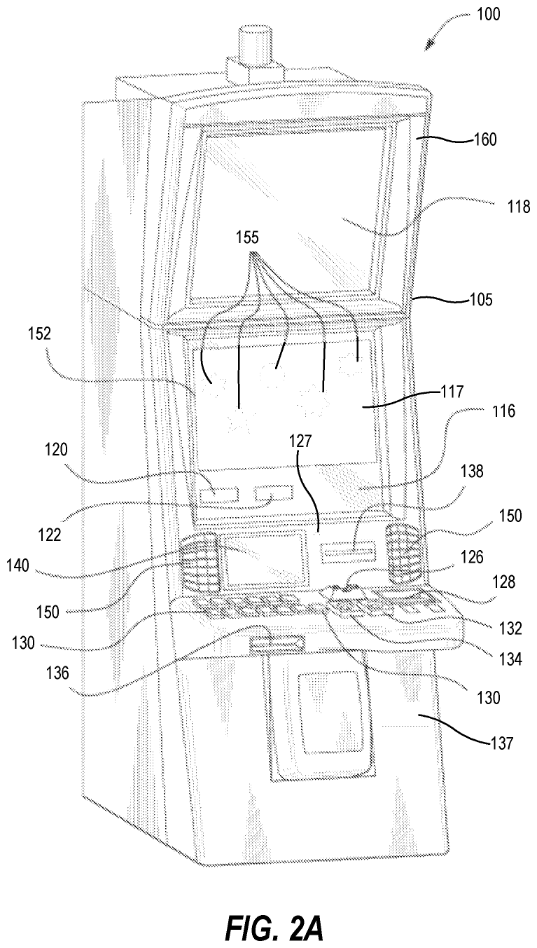

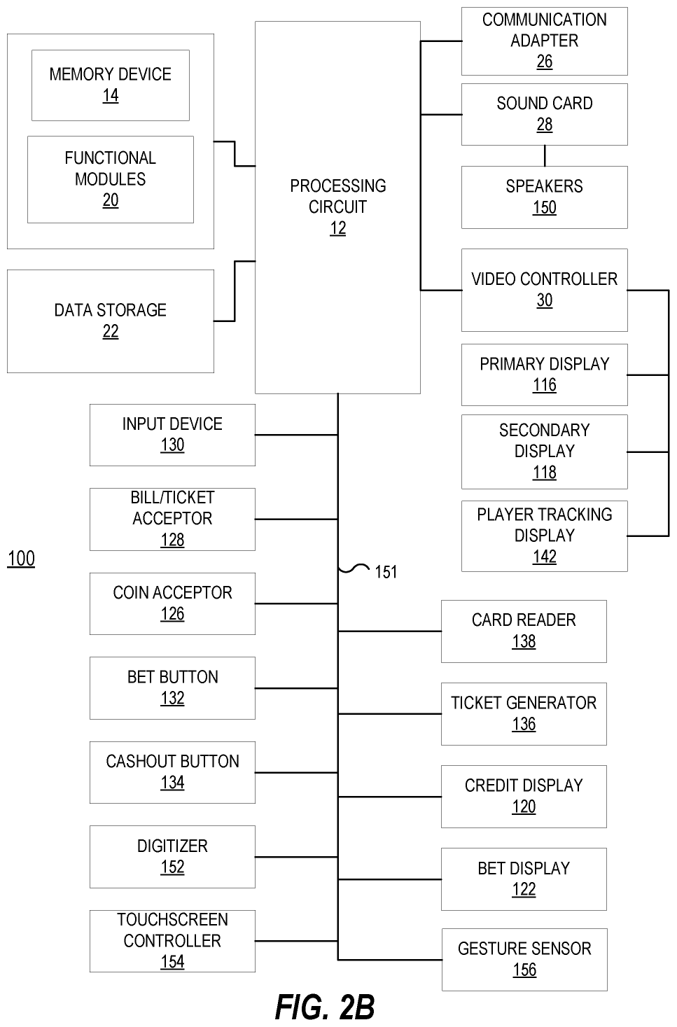

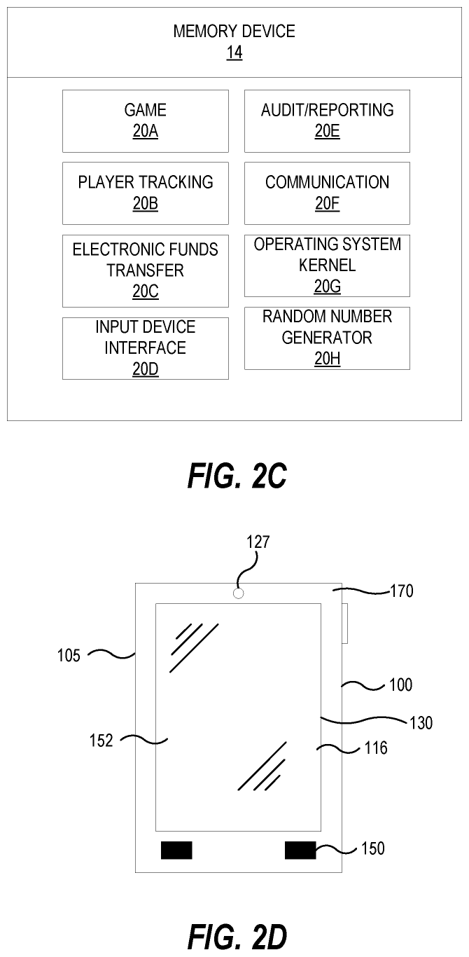

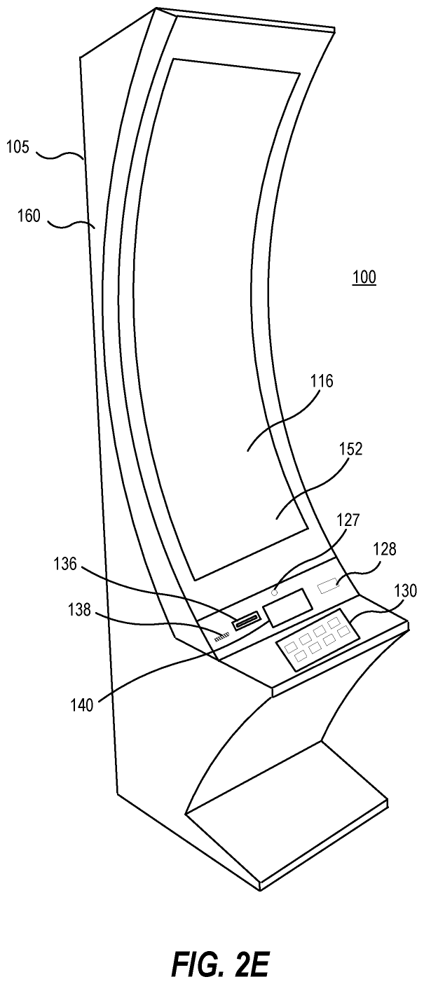

Embodiments herein may include different types of gaming devices. One example of a gaming device includes a gaming device 100 that can use gesture and/or touch-based inputs according to various embodiments is illustrated in FIGS. 2A, 2B, and 2C in which FIG. 2A is a perspective view of a gaming device 100 illustrating various physical features of the device, FIG. 2B is a functional block diagram that schematically illustrates an electronic relationship of various elements of the gaming device 100, and FIG. 2C illustrates various functional modules that can be stored in a memory device of the gaming device 100. The embodiments shown in FIGS. 2A to 2C are provided as examples for illustrative purposes only. It will be appreciated that gaming devices may come in many different shapes, sizes, layouts, form factors, and configurations, and with varying numbers and types of input and output devices, and that embodiments are not limited to the particular gaming device structures described herein.

Gaming devices 100 typically include a number of standard features, many of which are illustrated in FIGS. 2A and 2B. For example, referring to FIG. 2A, a gaming device 100 (which is an EGM 160 in this embodiment) may include a support structure, housing 105 (e.g., cabinet) which provides support for a plurality of displays, inputs, outputs, controls and other features that enable a player to interact with the gaming device 100.

The gaming device 100 illustrated in FIG. 2A includes a number of display devices, including a primary display device 116 located in a central portion of the housing 105 and a secondary display device 118 located in an upper portion of the housing 105. A plurality of game components 155 are displayed on a display screen 117 of the primary display device 116. It will be appreciated that one or more of the display devices 116, 118 may be omitted, or that the display devices 116, 118 may be combined into a single display device. The gaming device 100 may further include a player tracking display 142, a credit display 120, and a bet display 122. The credit display 120 displays a player's current number of credits, cash, account balance or the equivalent. The bet display 122 displays a player's amount wagered. Locations of these displays are merely illustrative as any of these displays may be located anywhere on the gaming device 100.

The player tracking display 142 may be used to display a service window that allows the player to interact with, for example, their player loyalty account to obtain features, bonuses, comps, etc. In other embodiments, additional display screens may be provided beyond those illustrated in FIG. 2A. In some embodiments, one or more of the player tracking display 142, the credit display 120 and the bet display 122 may be displayed in one or more portions of one or more other displays that display other game related visual content. For example, one or more of the player tracking display 142, the credit display 120 and the bet display 122 may be displayed in a picture in a picture on one or more displays.

The gaming device 100 may further include a number of input devices 130 that allow a player to provide various inputs to the gaming device 100, either before, during or after a game has been played. The gaming device may further include a game play initiation button 132 and a cashout button 134. The cashout button 134 is utilized to receive a cash payment or any other suitable form of payment corresponding to a quantity of remaining credits of a credit display.

In some embodiments, one or more input devices of the gaming device 100 are one or more game play activation devices that are each used to initiate a play of a game on the gaming device 100 or a sequence of events associated with the gaming device 100 following appropriate funding of the gaming device 100. The example gaming device 100 illustrated in FIGS. 2A and 2B includes a game play activation device in the form of a game play initiation button 132. It should be appreciated that, in other embodiments, the gaming device 100 begins game play automatically upon appropriate funding rather than upon utilization of the game play activation device.

In some embodiments, one or more input device 130 of the gaming device 100 may include wagering or betting functionality. For example, a maximum wagering or betting function may be provided that, when utilized, causes a maximum wager to be placed. Another such wagering or betting function is a repeat the bet device that, when utilized, causes the previously-placed wager to be placed. A further such wagering or betting function is a bet one function. A bet is placed upon utilization of the bet one function. The bet is increased by one credit each time the bet one device is utilized. Upon the utilization of the bet one function, a quantity of credits shown in a credit display (as described below) decreases by one, and a number of credits shown in a bet display (as described below) increases by one.

In some embodiments, as shown in FIG. 2B, the input device(s) 130 may include and/or interact with additional components, such as gesture sensors 156 for gesture input devices, and/or a touch-sensitive display that includes a digitizer 152 and a touchscreen controller 154 for touch input devices, as disclosed herein. The player may interact with the gaming device 100 by touching virtual buttons on one or more of the display devices 116, 118, 140. Accordingly, any of the above-described input devices, such as the input device 130, the game play initiation button 132 and/or the cashout button 134 may be provided as virtual buttons or regions on one or more of the display devices 116, 118, 140.

Referring briefly to FIG. 2B, operation of the primary display device 116, the secondary display device 118 and the player tracking display 142 may be controlled by a video controller 30 that receives video data from a processing circuit 12 or directly from a memory device 14 and displays the video data on the display screen. The credit display 120 and the bet display 122 are typically implemented as simple liquid crystal display (LCD) or light emitting diode (LED) displays that display a number of credits available for wagering and a number of credits being wagered on a particular game. Accordingly, the credit display 120 and the bet display 122 may be driven directly by the processing circuit 12. In some embodiments however, the credit display 120 and/or the bet display 122 may be driven by the video controller 30.

Referring again to FIG. 2A, the display devices 116, 118, 140 may include, without limitation: a cathode ray tube, a plasma display, an LCD, a display based on LEDs, a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display devices 116, 118, 140 may include a touch-screen with an associated touchscreen controller 154 and digitizer 152. The display devices 116, 118, 140 may be of any suitable size, shape, and/or configuration. The display devices 116, 118, 140 may include flat or curved display surfaces.

The display devices 116, 118, 140 and video controller 30 of the gaming device 100 are generally configured to display one or more game and/or non-game images, symbols, and indicia. In certain embodiments, the display devices 116, 118, 140 of the gaming device 100 are configured to display any suitable visual representation or exhibition of the movement of objects; dynamic lighting; video images; images of people, characters, places, things, and faces of cards; and the like. In certain embodiments, the display devices 116, 118, 140 of the gaming device 100 are configured to display one or more virtual reels, one or more virtual wheels, and/or one or more virtual dice. In other embodiments, certain of the displayed images, symbols, and indicia are in mechanical form. That is, in these embodiments, the display device 116, 118, 140 includes any electromechanical device, such as one or more rotatable wheels, one or more reels, and/or one or more dice, configured to display at least one or a plurality of game or other suitable images, symbols, or indicia.

The gaming device 100 also includes various features that enable a player to deposit credits in the gaming device 100 and withdraw credits from the gaming device 100, such as in the form of a payout of winnings, credits, etc. For example, the gaming device 100 may include a bill/ticket dispenser 136, a bill/ticket acceptor 128, and a coin acceptor 126 that allows the player to deposit coins into the gaming device 100.

As illustrated in FIG. 2A, the gaming device 100 may also include a currency dispenser 137 that may include a note dispenser configured to dispense paper currency and/or a coin generator configured to dispense coins or tokens in a coin payout tray.

The gaming device 100 may further include one or more speakers 150 controlled by one or more sound cards 28 (FIG. 2B). The gaming device 100 illustrated in FIG. 2A includes a pair of speakers 150. In other embodiments, additional speakers, such as surround sound speakers, may be provided within or on the housing 105. Moreover, the gaming device 100 may include built-in seating with integrated headrest speakers.

In various embodiments, the gaming device 100 may generate dynamic sounds coupled with attractive multimedia images displayed on one or more of the display devices 116, 118, 140 to provide an audio-visual representation or to otherwise display full-motion video with sound to attract players to the gaming device 100 and/or to engage the player during gameplay. In certain embodiments, the gaming device 100 may display a sequence of audio and/or visual attraction messages during idle periods to attract potential players to the gaming device 100. The videos may be customized to provide any appropriate information.

The gaming device 100 may further include a card reader 138 that is configured to read magnetic stripe cards, such as player loyalty/tracking cards, chip cards, and the like. In some embodiments, a player may insert an identification card into a card reader of the gaming device. In some embodiments, the identification card is a smart card having a programmed microchip or a magnetic strip coded with a player's identification, credit totals (or related data) and other relevant information. In other embodiments, a player may carry a portable device, such as a cell phone, a radio frequency identification tag or any other suitable wireless device, which communicates a player's identification, credit totals (or related data) and other relevant information to the gaming device. In some embodiments, money may be transferred to a gaming device through electronic funds transfer. When a player funds the gaming device, the processing circuit determines the amount of funds entered and displays the corresponding amount on the credit or other suitable display as described above.

In some embodiments, the gaming device 100 may include an electronic payout device or module configured to fund an electronically recordable identification card or smart card or a bank or other account via an electronic funds transfer to or from the gaming device 100.

FIG. 2B is a block diagram that illustrates logical and functional relationships between various components of a gaming device 100. It should also be understood that components described in FIG. 2B may also be used in other computing devices, as desired, such as mobile computing devices for example. As shown in FIG. 2B, the gaming device 100 may include a processing circuit 12 that controls operations of the gaming device 100. Although illustrated as a single processing circuit, multiple special purpose and/or general-purpose processors and/or processor cores may be provided in the gaming device 100. For example, the gaming device 100 may include one or more of a video processor, a signal processor, a sound processor and/or a communication controller that performs one or more control functions within the gaming device 100. The processing circuit 12 may be variously referred to as a “controller,” “microcontroller,” “microprocessor” or simply a “computer.” The processor may further include one or more application-specific integrated circuits (ASICs).

Various components of the gaming device 100 are illustrated in FIG. 2B as being connected to the processing circuit 12. It will be appreciated that the components may be connected to the processing circuit 12 through a system bus 151, a communication bus and controller, such as a universal serial bus (USB) controller and USB bus, a network interface, or any other suitable type of connection.

The gaming device 100 further includes a memory device 14 that stores one or more functional modules 20. Various functional modules 20 of the gaming device 100 will be described in more detail below in connection with FIG. 2D.

The memory device 14 may store program code and instructions, executable by the processing circuit 12, to control the gaming device 100. The memory device 14 may also store other data such as image data, event data, player input data, random or pseudo-random number generators, pay-table data or information and applicable game rules that relate to the play of the gaming device. The memory device 14 may include random access memory (RAM), which can include non-volatile RAM (NVRAM), magnetic RAM (ARAM), ferroelectric RAM (FeRAM) and other forms as commonly understood in the gaming industry. In some embodiments, the memory device 14 may include read only memory (ROM). In some embodiments, the memory device 14 may include flash memory and/or EEPROM (electrically erasable programmable read only memory). Any other suitable magnetic, optical and/or semiconductor memory may operate in conjunction with the gaming device disclosed herein.

The gaming device 100 may further include a data storage 22, such as a hard disk drive or flash memory. The data storage 22 may store program data, player data, audit trail data or any other type of data. The data storage 22 may include a detachable or removable memory device, including, but not limited to, a suitable cartridge, disk, CD ROM, Digital Video Disc (“DVD”) or USB memory device.

The gaming device 100 may include a communication adapter 26 that enables the gaming device 100 to communicate with remote devices over a wired and/or wireless communication network, such as a local area network (LAN), wide area network (WAN), cellular communication network, or other data communication network. The communication adapter 26 may further include circuitry for supporting short range wireless communication protocols, such as Bluetooth and/or NFC that enable the gaming device 100 to communicate, for example, with a mobile communication device operated by a player.

The gaming device 100 may include one or more internal or external communication ports that enable the processing circuit 12 to communicate with and to operate with internal or external peripheral devices, such as eye tracking devices, position tracking devices, cameras, accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, Small Computer System Interface (“SCSI”) ports, solenoids, speakers, thumb drives, ticket readers, touch screens, trackballs, touchpads, wheels, and wireless communication devices. In some embodiments, internal or external peripheral devices may communicate with the processing circuit through a USB hub (not shown) connected to the processing circuit 12.

In some embodiments, the gaming device 100 may include a sensor, such as a camera 127, in communication with the processing circuit 12 (and possibly controlled by the processing circuit 12) that is selectively positioned to acquire an image of a player actively using the gaming device 100 and/or the surrounding area of the gaming device 100. In one embodiment, the camera 127 may be configured to selectively acquire still or moving (e.g., video) images and may be configured to acquire the images in either an analog, digital or other suitable format. The display devices 116, 118, 140 may be configured to display the image acquired by the camera 127 as well as display the visible manifestation of the game in split screen or picture-in-picture fashion. For example, the camera 127 may acquire an image of the player and the processing circuit 12 may incorporate that image into the primary and/or secondary game as a game image, symbol or indicia.

Various functional modules of that may be stored in a memory device 14 of a gaming device 100 are illustrated in FIG. 2C. Referring to FIG. 2C, the gaming device 100 may include in the memory device 14 a game module 20A that includes program instructions and/or data for operating a hybrid wagering game as described herein. The gaming device 100 may further include a player tracking module 20B, an electronic funds transfer module 20C, an input device interface 20D, an audit/reporting module 20E, a communication module 20F, an operating system kernel 20G and a random number generator 20H. The player tracking module 20B keeps track of the play of a player. The electronic funds transfer module 20C communicates with a back-end server or financial institution to transfer funds to and from an account associated with the player. The input device interface 20D interacts with input devices, such as the input device 130, as described in more detail below. The communication module 20F enables the gaming device 100 to communicate with remote servers and other gaming devices using various secure communication interfaces. The operating system kernel 20G controls the overall operation of the gaming device 100, including the loading and operation of other modules. The random number generator 20H generates random or pseudorandom numbers for use in the operation of the hybrid games described herein.

In some embodiments, a gaming device 100 includes a personal device, such as a desktop computer, a laptop computer, a mobile device, a tablet computer or computing device, a personal digital assistant (PDA), or other portable computing devices. In some embodiments, the gaming device 100 may be operable over a wireless network, such as part of a wireless gaming system. In such embodiments, the gaming machine may be a hand-held device, a mobile device or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission.

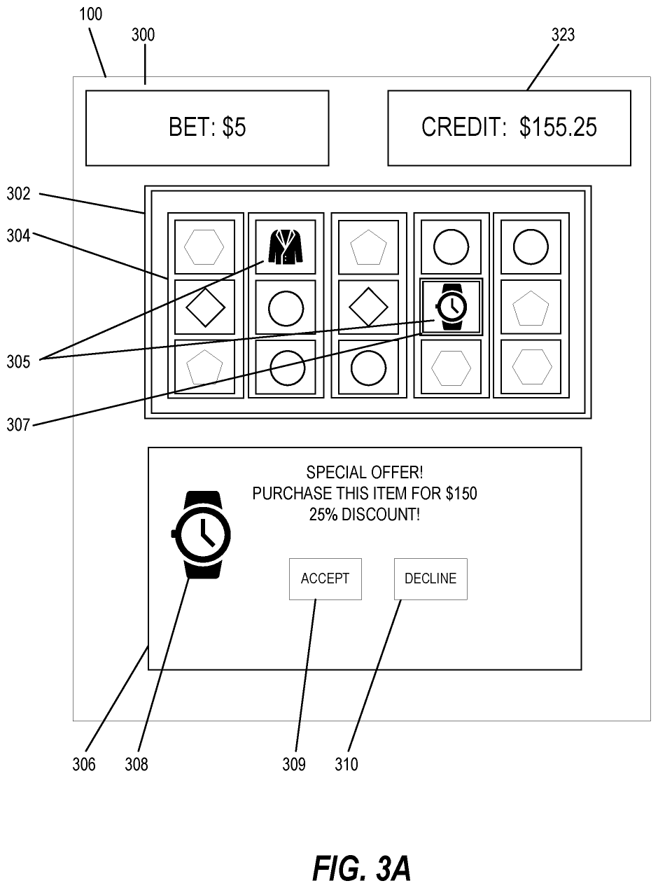

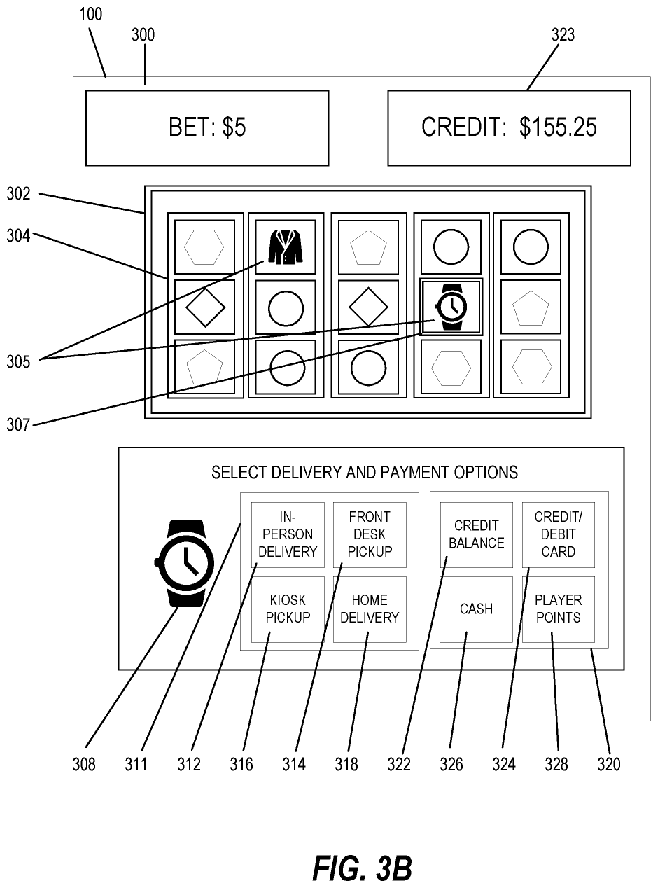

For example, referring to FIG. 2D, a gaming device 100 (which is a mobile gaming device 170 in this embodiment) may be implemented as a handheld device including a compact housing 105 on which is mounted a touchscreen display device 116 including a digitizer 152. As described in greater detail with respect to FIG. 3 below, one or more input devices 130 may be included for providing functionality of for embodiments described herein. A camera 127 may be provided in a front face of the housing 105. The housing 105 may include one or more speakers 150. In the gaming device 100, various input buttons described above, such as the cashout button, gameplay activation button, etc., may be implemented as soft buttons on the touchscreen display device 116 and/or input device 130. In this embodiment, the input device 130 is integrated into the touchscreen display device 116, but it should be understood that the input device may also, or alternatively, be separate from the display device 116. Moreover, the gaming device 100 may omit certain features, such as a bill acceptor, a ticket generator, a coin acceptor or dispenser, a card reader, secondary displays, a bet display, a credit display, etc. Credits can be deposited in or transferred from the gaming device 100 electronically.

FIG. 2E illustrates a standalone gaming device 100 (which is an EGM 160 in this embodiment) having a different form factor from the EGM 160 illustrated in FIG. 2A. In particular, the gaming device 100 is characterized by having a large, high aspect ratio, curved primary display device 116 provided in the housing 105, with no secondary display device. The primary display device 116 may include a digitizer 152 to allow touchscreen interaction with the primary display device 116. The gaming device 100 may further include a player tracking display 142, an input device 130, a bill/ticket acceptor 128, a card reader 138, and a bill/ticket dispenser 136. The gaming device 100 may further include one or more cameras 127 to enable facial recognition and/or motion tracking.

Although illustrated as certain gaming devices, such as electronic gaming machines (EGMs) and mobile gaming devices, functions and/or operations as described herein may also include wagering stations that may include electronic game tables, conventional game tables including those involving cards, dice and/or roulette, and/or other wagering stations such as sports book stations, video poker games, skill-based games, virtual casino-style table games, or other casino or non-casino style games. Further, gaming devices according to embodiments herein may be implemented using other computing devices and mobile devices, such as smart phones, tablets, and/or personal computers, among others.

FIGS. 3A and 3B are diagrams of a GUI 300 for an EGM 100 in a casino environment illustrating a purchase offer based on a player status of a player, according to some embodiments. As shown by FIG. 3A, the GUI 300 may include a wagering game 302 comprising a plurality of game elements 304. The EGM 100 may determine a player status of the player in a play session of the wagering game 302 at the gaming device 100. The player status may include a themed item based on the wagering game. The physical item 308 may be exclusively available at the casino, and/or may be part of a collectible set of physical items, with additional physical items in the collectible set is exclusively available at different casinos, and/or associated with different wagering games.

Based on the player status of the player, the GUI 300 may display an offer 306 to the player to purchase a physical item 308, such as apparel, jewelry, accessories, or other items. The GUI 300 may further include options to accept 309 or decline 310 the purchase offer 306. Alternatively or in addition, the player may indicate acceptance or non-acceptance of the purchase offer 306 via other input methods, such as input devices on the EGM 100 and/or a connected device, such as a mobile phone or tablet for example.

As shown by FIG. 3B, in response to acceptance of the offer by the player, the GUI 300 may display one or more options 311 for delivery of the physical item 308 to the player. It should be understood that the method of delivery may be predetermined and may not necessarily be presented to the player for selection. The options 311 may include fewer options than those shown in FIG. 3B, or more, as desired. In this example, the options 311 may include an option 312 for the physical item 308 to be delivered to the EGM 100, e.g., brought directly to the player. The options 311 may further include an option 314 for the player to take delivery of the physical item 308 at a customer service area elsewhere in the casino and/or at another location. The options 311 may further include an option 316 for the player to take delivery of the physical item 308 from a vending kiosk located elsewhere in the casino and/or at another location. The options 311 may further include an option 318 to ship the physical item 308 to a home address of the player and/or another location.

The GUI 300 may also display one or more options 320 for payment for the physical item 308. For example, the options 320 may including an option 322 to deduct the cost of the physical item 308 from a credit meter balance 323 at the EGM 100, an option 324 to pay using a credit and/or debit card, e.g., via a card reader 138 of the EGM 100, an option 326 to pay using cash, e.g., via a bill acceptor 128 of the EGM 100, and/or an option 326 for non-monetary payment, such as using accumulated player points from a player points balance associated with the player to purchase the physical item 308. It should be understood that any number of payment methods may be used and/or made available for purchase of the physical item, as desired.

In response to acceptance of the offer 306 by the player, and/or selection of a delivery option 311 and/or payment option 320 transmit an instruction to prepare the physical item for delivery to the player, to be delivered to the player after completion of the wagering game play session.

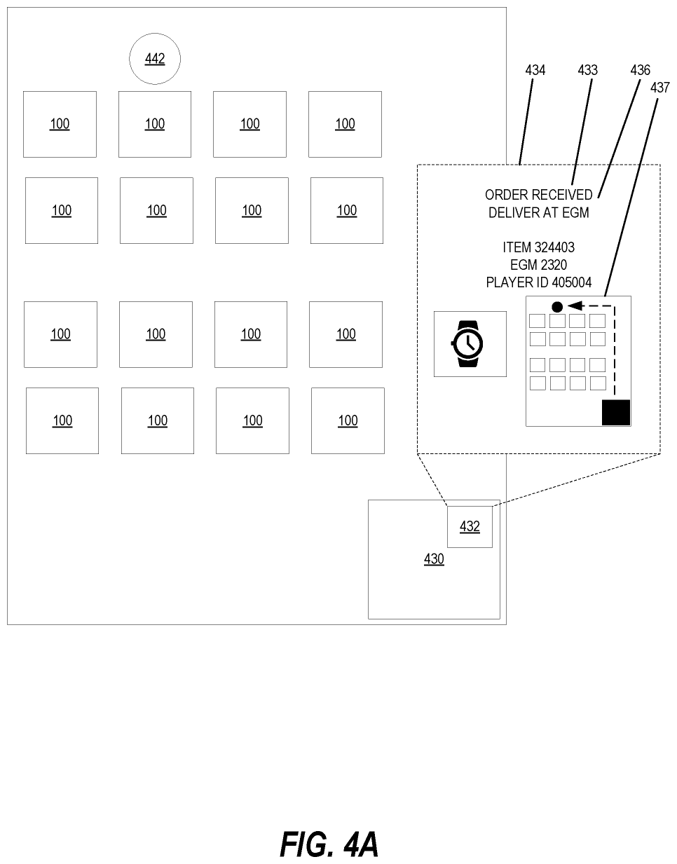

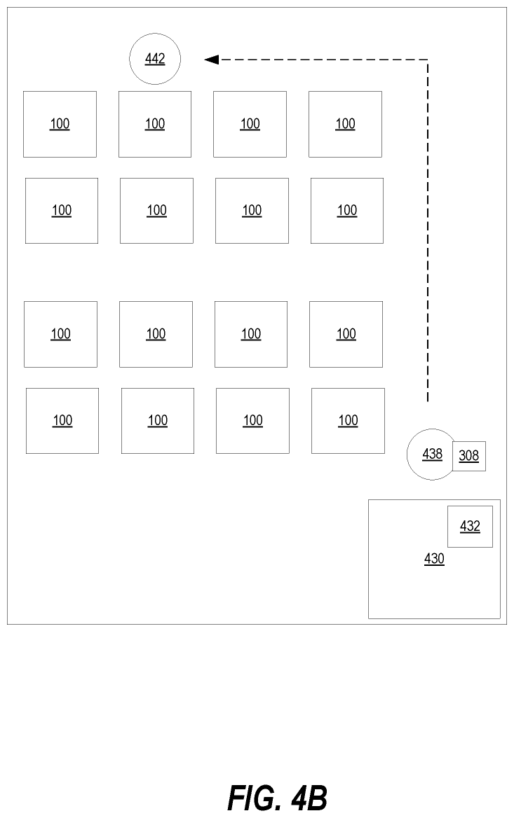

FIGS. 4A and 4B illustrate delivery of the physical item 308 to a player 442 at the EGM 100. In this example, in response to acceptance of the offer 306 by the player and selection of the option 312 for the physical item 308 to be delivered to the EGM 100, the EGM 100 causes an instruction to be transmitted to prepare the physical item 308 for delivery to the player.

As shown in FIG. 4A, in response to transmission of the instruction, a customer service terminal 432 in a customer service area 430 may provide an indication 433 to prepare the physical item 308 for delivery. In this example, the indication 433 may be provided as a message 436 and/or a graphical map 437 in a GUI 434 of the terminal 432, but it should be understood that other types of indication may be provided, as desired, to alert a customer service representative 438 to the purchase of the physical item 308 and to provide directions for in-person delivery of the item 308.

As shown in FIG. 4B, in response to the indication 433, the representative 438 or another person may transport the physical item 308 to the EGM 100 for delivery to the player 442 at the EGM 100.

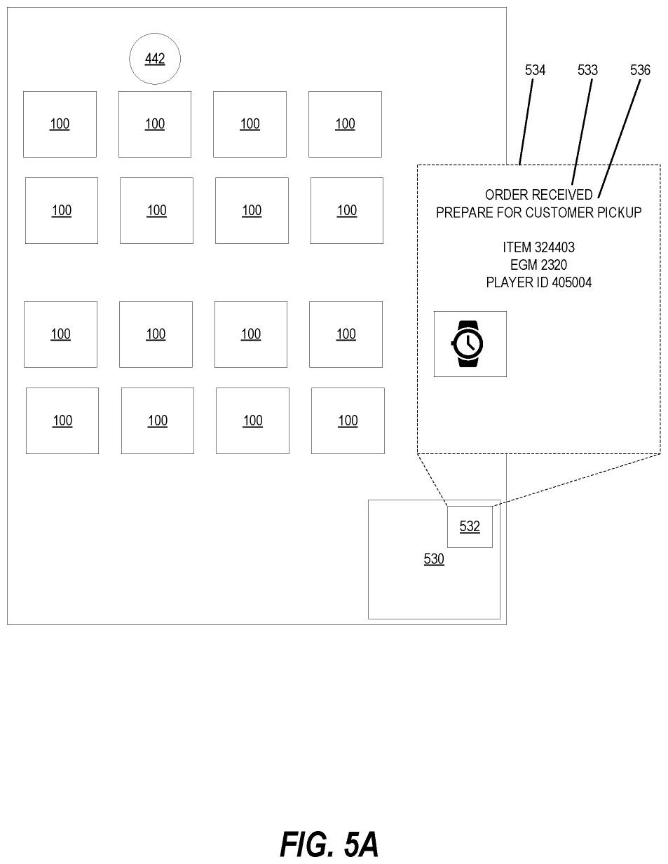

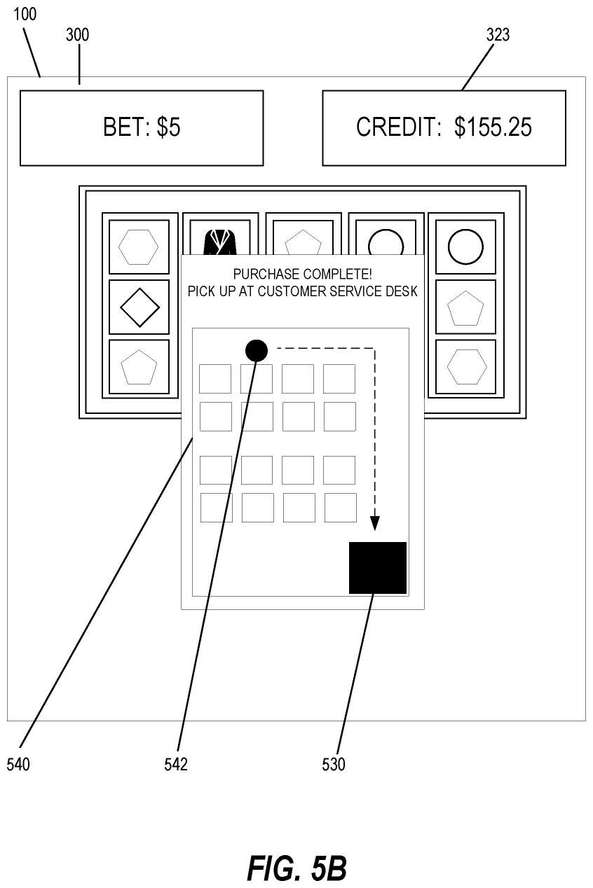

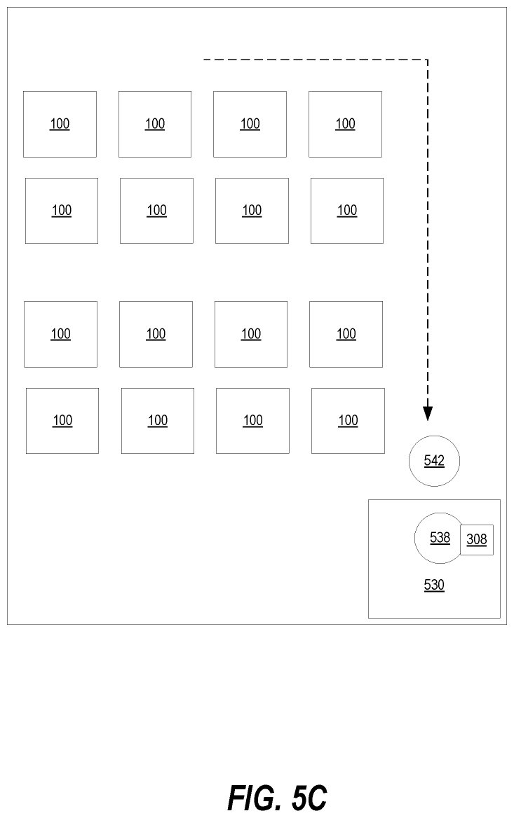

FIGS. 5A-5C illustrate the player 542 taking delivery of the physical item 308 at a customer service area 530 elsewhere in the casino and/or at another location. In this example, in response to acceptance of the offer 306 by the player and selection of the option 314 to take delivery at the customer service area 530, the EGM 100 causes an instruction to be transmitted to prepare the physical item 308 for delivery to the player.

As shown in FIG. 5A, in response to transmission of the instruction, a customer service terminal 532 in a customer service area 530 may provide an indication 533 to prepare the physical item 308 for delivery. In this example, the indication 533 may be provided as a message 536 in a GUI 534 of the terminal 532, but it should be understood that other types of indication may be provided, as desired, to alert a customer service representative 538 to the purchase of the physical item 308.

As shown by FIG. 5B, the GUI 300 of the EGM 100 may further display location information 540 for the customer service area 530 at the EGM 100 after completion of the wagering game session, for example to help the player 542 locate the customer service area 530 in the casino.

As shown by FIG. 5C, the player 542 may arrive at the customer service area 530 after the game play session at the EGM 100 is completed to take delivery of the item 308 at the customer service area 530. Because the instruction to prepare the physical item 308 for delivery has already been transmitted while the player 542 is at the EGM 100, the customer service representative 538 may have adequate time to have the physical item 308 ready for delivery when the player 542 arrives at the customer service area 530.

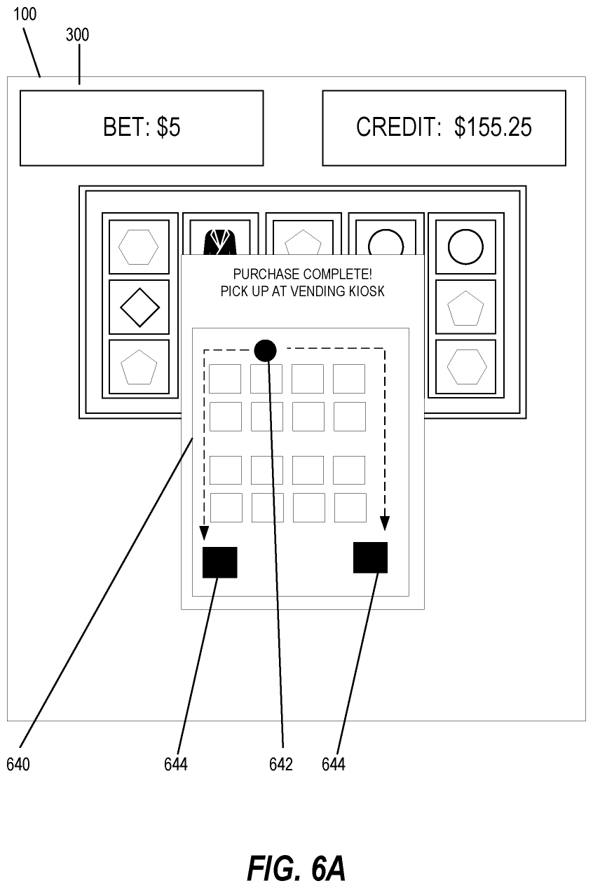

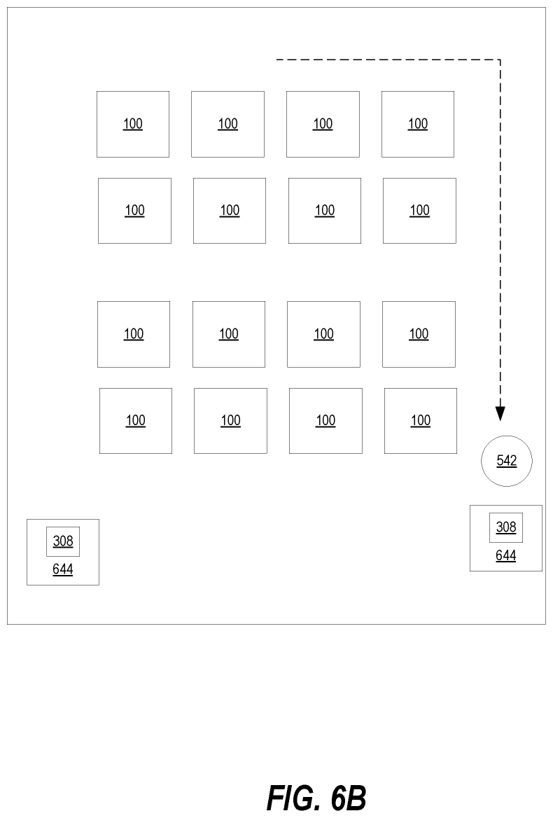

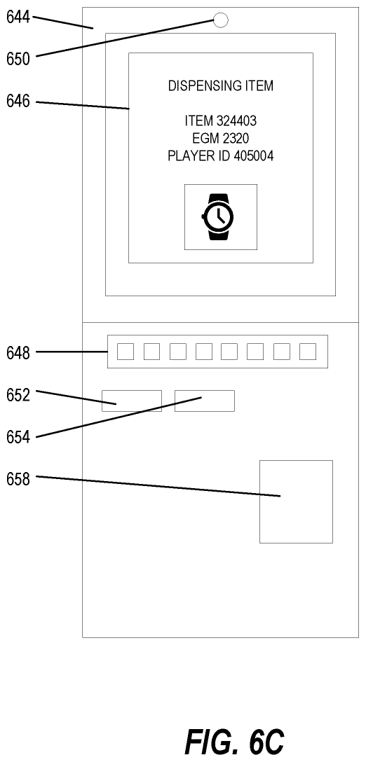

FIGS. 6A-6C illustrate the player 642 taking delivery of the physical item 308 at a from one or more vending kiosks 644 elsewhere in the casino and/or at another location. As shown in FIG. 6A, the GUI 300 of the EGM 100 may further display location information 640 for the vending kiosks 644 at the EGM 100 after completion of the wagering game session, for example to help the player 642 locate the vending kiosk 644 in the casino.

In this example, in response to acceptance of the offer 306 by the player and selection of the option 316 to take delivery at vending kiosk 644, the EGM 100 causes an instruction to be transmitted to prepare the physical item 308 for delivery to the player. Alternatively, or in addition, the instruction may be provided at the time of redemption, e.g., when the player 642 arrives at the kiosk 644 (see FIG. 6B). For example, as shown in FIG. 6C, the kiosk 644 may include a display 646 and one or more input devices 648 for receiving input from the player 642. The kiosk 644 may include a camera 650 for monitoring an area around the kiosk 644 and/or identifying the player 642, and may further include a card reader 652, a bill/ticket acceptor/dispenser 654, and an item dispenser 658, as desired.

In the example of FIG. 6C, in response to identification of the player, e.g., via the camera 650 identifying the player 642 from a captured image and/or via the card reader identifying the player 642 from an inserted player card and/or credit card, an instruction is generated to cause the vending kiosk 644 to deliver the physical item 308 to the player 642. In some examples, the vending kiosk 644 may determine that the item 308 has been paid for, e.g., at the EGM 100, and/or may accept payment for the item 308 directly, e.g., via a player card and/or credit card, etc.

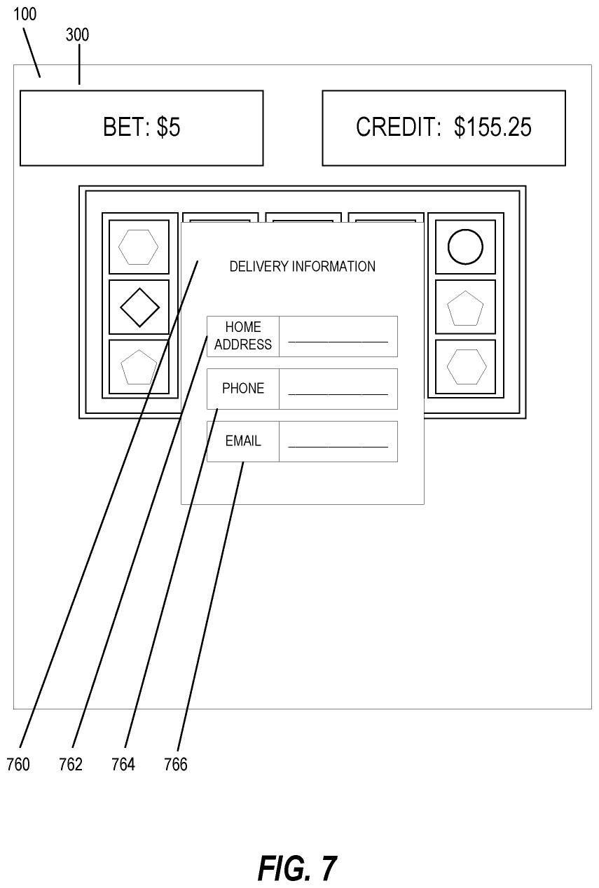

FIG. 7 illustrates initiating shipping of the purchased physical item 308 to a selected address of player at the EGM 100. In this example, in response to acceptance of the offer 306 by the player and selection of the option 318 for the physical item 308 to be shipped, the GUI 300 of the EGM 100 displays an interface for providing and confirming delivery information 760 for the item 308. The delivery information 760 may include address information 762, e.g., for a home address and/or other selected physical address for the player, phone number information 764, email information 766, and/or any other information for identifying, confirming, and/or tracking information associated with the player and/or shipment and delivery of the item 308. Following entry and/or confirmation of the delivery information 760 by the player, the EGM 100 causes an instruction to be transmitted to prepare the physical item 308 for shipment, e.g., by a customer service representative similar to the customer service representatives discussed above with respect to FIGS. 4A-5C.

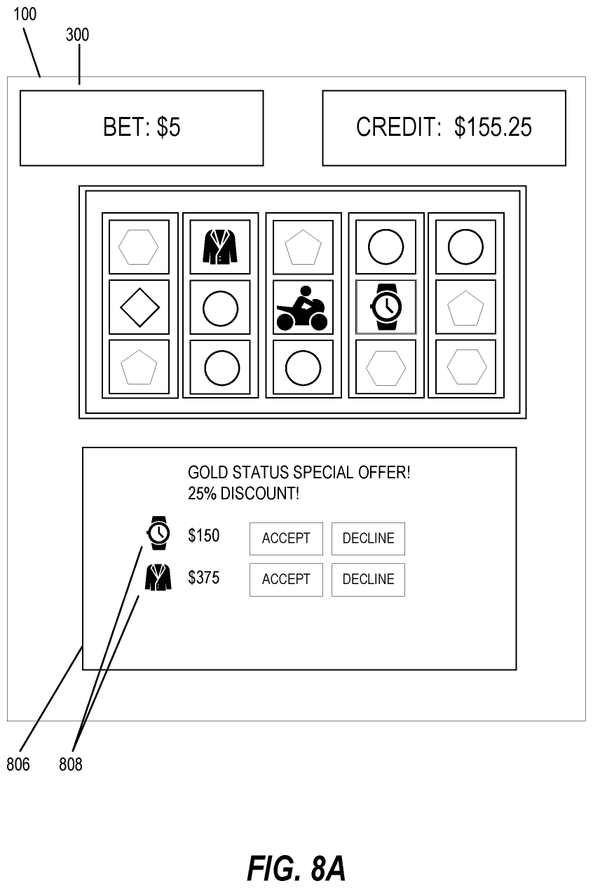

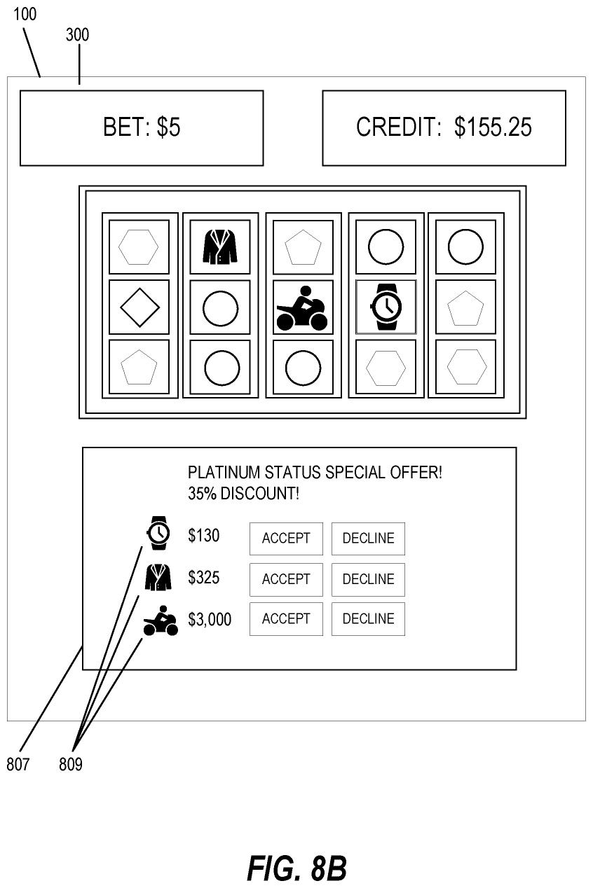

In some examples, the type of purchase offer may vary based on a player status of the player. In this regard, FIGS. 8A and 8B illustrate offering different purchase offers in response to different player statuses. For example, as shown by FIG. 8A, based on the player status of the player being a first status, the GUI 300 may display a first plurality of purchase offers 806 for a first plurality of physical items 808. As shown by FIG. 8B, based on the player status of the player being a second status, the GUI 300 may display a second plurality of purchase offers 807 for a second plurality of physical items 809. For example, the different statuses may be based on playing a predetermined number of wagering games during the game session and/or within a predetermined time period, for example.

In some examples, a subset of the second plurality of purchase offers 807 may not include in the first plurality of purchase offers 806 and/or vice versa. For example, the first plurality of physical items 808 and the second plurality of physical items 809 may be the same, but the offers 806, 807 and/or terms thereof may differ based on the different player statuses. For example, a player with gold player status may be offered two items at a 25% discount. In other examples, the physical items 808, 809 available for purchase may differ based on the different player statuses. For example, a player with platinum player status in a similar game play situation may be offered three items at a higher 35% discount.

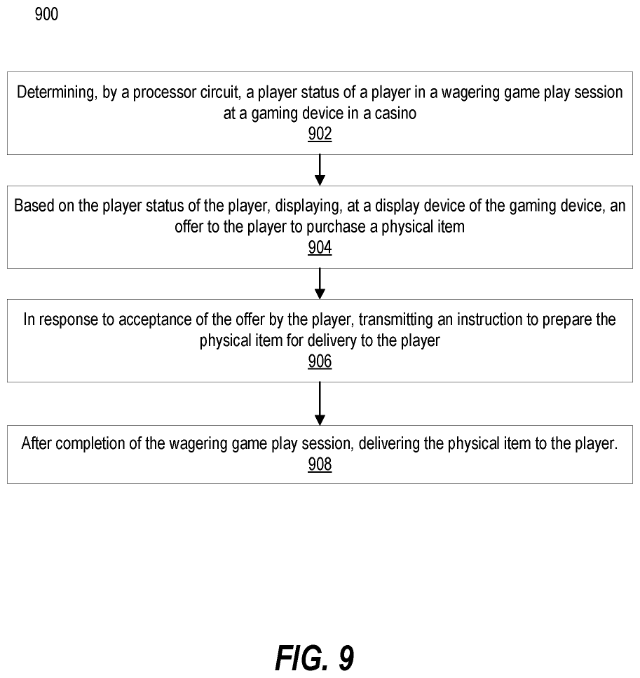

FIG. 9 is a flowchart illustrating operations 900 for providing purchase offers to a player of a wagering game at a gaming device in a casino environment. In this regard, the operations 900 may include determining, by a processor circuit, a player status of a player in a wagering game play session at a gaming device in a casino (Block 902). For example, as shown in FIGS. 8A and 8B, players with different player statuses may have similar game results.

The operations 900 may further include, based on the player status of the player, displaying, at a display device of the gaming device, an offer to the player to purchase a physical item (Block 904). For example, as shown in FIGS. 8A and 8B, players with different player statuses may be offered different groups of offers 806, 807 based on the different respective player statuses.

The operations 900 may further include, in response to acceptance of the offer by the player, transmitting an instruction to prepare the physical item for delivery to the player (Block 906). As shown in FIGS. 3A and 3B et al., acceptance of a purchase offer 306 cause an instruction to be transmitted to prepare the item 308 for delivery, e.g., by in-person delivery (FIGS. 4A and 4B), customer pickup (FIGS. 5A-6C), home delivery (FIG. 7), etc., as desired.

The operations 900 may further include, after completion of the wagering game play session, delivering the physical item to the player (Block 908). For example, delivery may be performed using any of the methods described with respect to FIGS. 4A-7 and/or other methods, as desired.

Embodiments described herein may be implemented in various configurations for gaming devices 100, including but not limited to: (1) a dedicated gaming device, wherein the computerized instructions for controlling any games (which are provided by the gaming device) are provided with the gaming device prior to delivery to a gaming establishment; and (2) a changeable gaming device, where the computerized instructions for controlling any games (which are provided by the gaming device) are downloadable to the gaming device through a data network when the gaming device is in a gaming establishment. In some embodiments, the computerized instructions for controlling any games are executed by at least one central server, central controller or remote host. In such a “thin client” embodiment, the central server remotely controls any games (or other suitable interfaces), and the gaming device is utilized to display such games (or suitable interfaces) and receive one or more inputs or commands from a player. In another embodiment, the computerized instructions for controlling any games are communicated from the central server, central controller or remote host to a gaming device local processor and memory devices. In such a “thick client” embodiment, the gaming device local processor executes the communicated computerized instructions to control any games (or other suitable interfaces) provided to a player.

In some embodiments, a gaming device may be operated by a mobile device, such as a mobile telephone, tablet other mobile computing device. For example, a mobile device may be communicatively coupled to a gaming device and may include a user interface that receives user inputs that are received to control the gaming device. The user inputs may be received by the gaming device via the mobile device.

In some embodiments, one or more gaming devices in a gaming system may be thin client gaming devices and one or more gaming devices in the gaming system may be thick client gaming devices. In another embodiment, certain functions of the gaming device are implemented in a thin client environment and certain other functions of the gaming device are implemented in a thick client environment. In one such embodiment, computerized instructions for controlling any primary games are communicated from the central server to the gaming device in a thick client configuration and computerized instructions for controlling any secondary games or bonus functions are executed by a central server in a thin client configuration.

The present disclosure contemplates a variety of different gaming systems each having one or more of a plurality of different features, attributes, or characteristics. It should be appreciated that a “gaming system” as used herein refers to various configurations of: (a) one or more central servers, central controllers, or remote hosts; (b) one or more gaming devices; and/or (c) one or more personal gaming devices, such as desktop computers, laptop computers, tablet computers or computing devices, PDAs, mobile telephones such as smart phones, and other mobile computing devices.

In certain such embodiments, computerized instructions for controlling any games (such as any primary or base games and/or any secondary or bonus games) displayed by the gaming device are executed by the central server, central controller, or remote host. In such “thin client” embodiments, the central server, central controller, or remote host remotely controls any games (or other suitable interfaces) displayed by the gaming device, and the gaming device is utilized to display such games (or suitable interfaces) and to receive one or more inputs or commands. In other such embodiments, computerized instructions for controlling any games displayed by the gaming device are communicated from the central server, central controller, or remote host to the gaming device and are stored in at least one memory device of the gaming device. In such “thick client” embodiments, the at least one processor of the gaming device executes the computerized instructions to control any games (or other suitable interfaces) displayed by the gaming device.

In some embodiments in which the gaming system includes: (a) a gaming device configured to communicate with a central server, central controller, or remote host through a data network; and/or (b) a plurality of gaming devices configured to communicate with one another through a data network, the data network is an internet or an intranet. In certain such embodiments, an internet browser of the gaming device is usable to access an internet game page from any location where an internet connection is available. In one such embodiment, after the internet game page is accessed, the central server, central controller, or remote host identifies a player prior to enabling that player to place any wagers on any plays of any wagering games. In one example, the central server, central controller, or remote host identifies the player by requiring a player account of the player to be logged into via an input of a unique username and password combination assigned to the player. It should be appreciated, however, that the central server, central controller, or remote host may identify the player in any other suitable manner, such as by validating a player tracking identification number associated with the player; by reading a player tracking card or other smart card inserted into a card reader (as described below); by validating a unique player identification number associated with the player by the central server, central controller, or remote host; or by identifying the gaming device, such as by identifying the MAC address or the IP address of the internet facilitator. In various embodiments, once the central server, central controller, or remote host identifies the player, the central server, central controller, or remote host enables placement of one or more wagers on one or more plays of one or more primary or base games and/or one or more secondary or bonus games and displays those plays via the internet browser of the gaming device.

It should be appreciated that the central server, central controller, or remote host and the gaming device are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile internet network), or any other suitable medium. It should be appreciated that the expansion in the quantity of computing devices and the quantity and speed of internet connections in recent years increases opportunities for players to use a variety of gaming devices to play games from an ever-increasing quantity of remote sites. It should also be appreciated that the enhanced bandwidth of digital wireless communications may render such technology suitable for some or all communications, particularly if such communications are encrypted. Higher data transmission speeds may be useful for enhancing the sophistication and response of the display and interaction with players.

In the above description of various embodiments, various aspects may be illustrated and described herein in any of a number of patentable classes or contexts including any new and useful process, machine, manufacture, or composition of matter, or any new and useful improvement thereof. Accordingly, various embodiments described herein may be implemented entirely by hardware, entirely by software (including firmware, resident software, micro-code, etc.) or by combining software and hardware implementation that may all generally be referred to herein as a “circuit,” “module,” “component,” or “system.” Furthermore, various embodiments described herein may take the form of a computer program product including one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, radio frequency (“RF”), etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, Common Business Oriented Language (“COBOL”) 2002, PHP: Hypertext Processor (“PHP”), Advanced Business Application Programming (“ABAP”), dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Various embodiments were described herein with reference to flowchart illustrations and/or block diagrams of methods, apparatus (systems), devices and computer program products according to various embodiments described herein. It will be understood that each block of the flowchart illustrations and/or block diagrams, and combinations of blocks in the flowchart illustrations and/or block diagrams, can be implemented by computer program instructions. These computer program instructions may be provided to a processing circuit of a general purpose computer, special purpose computer, or other programmable data processing apparatus to produce a machine, such that the instructions, which execute via the processing circuit of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operations to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

What is claimed is:

1. A system comprising:
a processor circuit; and
a memory comprising machine-readable instructions that, when executed by the processor circuit, cause the processor circuit to:
determine a player status of a player in a wagering game play session at a gaming device in a casino;
based on the player status of the player, cause a display device of the gaming device to display an offer to the player to purchase a physical item;
in response to acceptance of the offer by the player, transmit an instruction to prepare the physical item for delivery to the player; and
after completion of the wagering game play session, cause the physical item to be delivered to the player.

2. The system of claim 1, wherein delivery of the physical item to the player comprises delivery of the physical item to the player at the gaming device.

3. The system of claim 1, wherein delivery of the physical item to the player comprises delivery of the physical item to the player at a customer service area of the casino.

4. The system of claim 3, wherein the instructions that cause delivery the physical item to the player further cause the processor circuit to:
display location information for the customer service area at the gaming device after completion of the wagering game session.

5. The system of claim 1, wherein the instructions that cause delivery the physical item to the player further cause the processor circuit to:
identify the player at a vending kiosk in the casino separate from the gaming device; and
in response to the identification of the player, dispense the physical item at the vending kiosk.

6. The system of claim 5, wherein the instructions that cause delivery the physical item to the player further cause the processor circuit to:
display location information for the vending kiosk at the gaming device after completion of the wagering game session.

7. The system of claim 1, wherein delivery of the physical item to the player comprises shipment of the physical item to a physical address associated with the player.

8. The system of claim 7, wherein the instructions that cause delivery the physical item to the player further cause the processor circuit to:
receive an indication at the gaming device from the player of the physical address associated with the player after completion of the wagering game session.

9. The system of claim 1, wherein the instructions that cause the display device to display the offer to the player further cause the processor circuit to:
based on the player status of the player being a first status, cause a display device of the gaming device to display a first plurality of purchase offers to the player; and
based on the player status of the player being a second status, cause a display device of the gaming device to display a second plurality of purchase offers to the player, wherein a subset of the second plurality of purchase offers is not included in the first plurality of purchase offers.

10. The system of claim 9, wherein the first status is based on the player playing a first predetermined number of wagering games during the wagering game play session, and
wherein the second status is based on the player playing a second predetermined number of wagering games during the wagering game play session higher than the first predetermined number of wagering games.

11. The system of claim 9, wherein the first status is based on the player playing a first predetermined number of wagering games in the casino during a predetermined time period, and
wherein the second status is based on the player playing a second predetermined number of wagering games in the casino during the predetermined time period higher than the first predetermined number of wagering games.

12. The system of claim 1, wherein the physical item is exclusively available at the casino.

13. The system of claim 12, wherein the physical item is part of a collectible set of physical items, and
wherein an additional physical item in the collectible set is exclusively available at a different casino.

14. The system of claim 1, wherein the physical item comprises a themed item based on the wagering game.

15. A gaming device comprising:
a display device;
an input device;
a processor circuit; and
a memory comprising machine-readable instructions that, when executed by the processor circuit, cause the processor circuit to:
determine a player status of a player in a wagering game play session at a gaming device in a casino;
based on the player status of the player being a first status, cause a display device of the gaming device to display a first plurality of purchase offers to the player; and
based on the player status of the player being a second status, cause a display device of the gaming device to display a second plurality of purchase offers to the player, wherein a subset of the second plurality of purchase offers is not included in the first plurality of purchase offers.

16. The gaming device of claim 15, wherein the first status is based on the player playing a first predetermined number of wagering games during the wagering game play session, and
wherein the second status is based on the player playing a second predetermined number of wagering games during the wagering game play session higher than the first predetermined number of wagering games.

17. The gaming device of claim 15, wherein the first status is based on the player playing a first predetermined number of wagering games in the casino during a predetermined time period, and
wherein the second status is based on the player playing a second predetermined number of wagering games in the casino during the predetermined time period higher than the first predetermined number of wagering games.

18. The gaming device of claim 14, wherein the instructions further cause the processor circuit to:
in response to acceptance of the offer by the player, transmit an instruction to prepare a purchased item for delivery to the player; and
after completion of the wagering game play session, deliver the purchased item to the player.

19. The gaming device of claim 15, wherein the instructions that cause delivery the purchased item to the player further cause the processor circuit to:
receive an indication at the gaming device from the player of a physical address associated with the player after completion of the wagering game session; and
cause the purchased item to be shipped to the physical address associated with the player.

20. A method comprising:
determining, by a processor circuit, a player status of a player in a wagering game play session at a gaming device in a casino;
based on the player status of the player, displaying, at a display device of the gaming device, an offer to the player to purchase a physical item;
in response to acceptance of the offer by the player, transmitting an instruction to prepare the physical item for delivery to the player; and
after completion of the wagering game play session, delivering the physical item to the player.
